(19) United States
(12) Patent Application Publication
(10) Pub. No.: US 2023/0013138 A1
(43) Pub. Date: Jan. 19, 2023

(54) METHOD AND MACHINE FOR PRINTING ON A WORKPIECE

(71) Applicant: HOMAG GmbH, Schopfloch (DE)

(72) Inventor: Johannes SCHMID, Starzach (DE)

(21) Appl. No.: 17/782,975

(22) PCT Filed: Dec. 4, 2020
(86) PCT No.: PCT/EP2020/084703

§ 371 Date: Jun. 6, 2022

(30) Foreign Application Priority Data
Dec. 6, 2019 (DE) 10 2019 133 336.9

(51) Int. Cl. B41J 3/28; B41J 3/407; B41J 3/54

(52) U.S. Cl. CPC B41J 3/286; B41J 3/4073; B41J 3/543

(57) ABSTRACT

The invention relates to a method for printing on a panel-like workpiece (W), which has wide faces and lateral faces, in the machine, which comprises at least one digital printing device (10), in particular an inkjet printing device, comprising the following steps: bringing ab out a relative movement between the workpiece and the at least one digital printing device and printing on at least one of the wide faces and at least one of the lateral faces of the workpiece (W) in the machine.

### TECHNICAL FIELD

The invention relates to a method for printing on a panel-like workpiece with a digital printing device, in particular an inkjet printing device. The invention also relates to a machine.

### PRIOR ART

In the field of furniture manufacturing, using a printing device to print on the wide face of panel-like workpieces and in this way to provide them with a decorative finish is known from the prior art.

For example, an apparatus for refining workpieces is described in EP 1 837 189 A1, which comprises: a printing device, which is preferably embodied as an inkjet printing device having a plurality of nozzles, from which drops of ink can be expelled, a workpiece carrying device for carrying the workpiece on which the pattern is to b e printed, and a conveyor for bringing about a relative movement between the workpiece to be refined and the printing device. Moreover, the apparatus described in EP 1 837 189 A1 is equipped with a machining device for machining the workpiece.

Although the apparatus described in EP 1 837 189 A1 has proved its worth, the demands in respect of the efficiency and range of applications of such apparatus are increasing.

### Subject Matter of the Invention

An object of the invention is thus to provide a method with which the refinement of workpieces can be carried out even more efficiently.

Claim 1 provides a corresponding method. Further preferred embodiments are mentioned in the dependent claims. The invention also relates to a machine.

The invention provides a method for printing on a panel-like workpiece, which has wide faces and lateral faces, in the machine, which comprises at least one digital printing device, for example an inkjet printing device. The method comprises the following steps: bringing about a relative movement between the workpiece and the at least one digital printing device and printing on the wide faces and the lateral faces of the workpiece in the machine.

The digital printing device, preferably inkjet printing device, can comprise a plurality of individually controllable nozzles, through which a printing medium is expelled.

The method according to the invention provides the advantage, inter alia, that multiple sides of the workpiece, in particular all sides of the workpiece, can b e printed on. The flexibility is significantly increased in this way, so that the method according to the invention is suitable for both small and large volumes. Furthermore, with the stated flexibility a high degree of efficiency is also made possible since a further coating of the workpiece, for example a narrow-face coating, can be omitted if appropriate. However, if a narrow-face coating is envisaged in order to seal the narrow face of a workpiece, then the printing process can be used to increase the variety of designs since a color can be applied individually to the workpiece.

According to a preferred embodiment, it is provided that the entire surface of each face of the workpiece is printed on, so that a decorative finish is formed on the corresponding face.

The machine preferably comprises a conveyor system, which can take the form of a conveyor belt or transport belt, for example. The conveyor system is suitable for bringing about a relative movement between the workpiece and the at least one digital printing device.

In one embodiment of the method, it is provided that the faces of the workpiece are printed on in a number of passes. In this case, a workpiece can be returned to the infeed of the machine again by means of a circulating device, for example.

After one of the faces of the workpiece has been printed on, the digital printing device can be pivoted. This allows, for example, a wide face of a workpiece to b e printed on first, and then, after pivoting the digital printing device, a narrow side of a pan el-like workpiece can be printed on.

The machine can comprise a number of digital printing devices for printing on the faces of the workpiece. These digital printing devices can be arranged, at least in part, one after another in a passage direction of the workpiece through the machine.

In a further embodiment, it is provided that the machine comprises at least four digital printing devices, wherein two of the digital printing devices are configured to print on in each case one of the wide faces of the workpiece and two of the digital printing devices are configured to print on in each case one of the lateral faces of the workpiece. This setup enables multiple faces of a workpiece to be printed on in a single pass.

It is preferable that the relative movement is a movement of the workpiece and that a change of direction takes place as the workpiece passes through the machine. In this way, faces of the workpiece that are oriented transversely to the direction of movement during a first movement can be oriented in the direction of movement following said change of direction. This enables multiple faces of the workpiece to be printed on in a single pass.

The workpiece that is printed on in the course of the method is preferably a workpiece consisting, at least in sections, of wood or a wood-based material. Purely by way of example, it can be a kitchen worktop, the front of a piece of furniture, a removable shelf, a floor panel, a panel for use in the structural components industry, or the like.

Furthermore, a machine/device for printing on a panel-like workpiece is provided, wherein such a workpiece has wide faces and lateral faces. The machine comprises: at least one digital printing device, in particular an inkjet printing device, and a device for bringing about a relative movement between the workpiece and the at least one digital printing device, wherein the machine is configured to print on at least one of the wide faces and at least one of the lateral faces of the workpiece.

The machine/device provides the advantage, inter alia, that multiple sides of the workpiece, in particular all sides of the workpiece, can be printed on. The flexibility is significantly increased in this way, so that the method according to the invention is suitable for both small and large volumes. Furthermore, with the stated flexibility a high degree of efficiency is also made possible since a further coating of the workpiece, for example a narrow-face coating, can be omitted if appropriate. However, if a narrow-face coating is envisaged in order to seal the narrow face of a workpiece, then the printing process can b e used to increase the variety of designs since a color can be applied individually to the workpiece.

In particular, the machine can be designed/configured to carry out a method in accordance with one of the above aspects. The machine can also be used as part of the method and/or can carry out corresponding method steps.

According to one embodiment, the at least one digital printing device is pivotable, preferably through at least 90°. In this way, a wide face and a lateral face of a panel-like workpiece can be printed on with one digital printing device.

It is preferable for the machine to comprise a number of digital printing devices for printing on faces of the workpiece. In this way, for example, faces of the workpiece can be printed on in one machine, successively and/or in parallel.

The machine can comprise at least four digital printing devices, with which in particular at least four faces of a workpiece can be printed on.

Two of the digital printing devices can be configured to print on in each case one of the wide faces of the workpiece and two of the digital printing devices can be configured to print on in each case one of the lateral faces of the workpiece. In this way, the machine can process high volumes.

Furthermore, the machine can include a device for rotating the workpiece. The device for rotating the workpiece is suitable/configured in particular for rotating the workpiece through 180°.

Moreover, according to a further embodiment of the machine, a conveyor system, in particular a conveyor belt or one or more transport belts, is provided in order to bring about a relative movement between the workpiece and the at least one digital printing device. Such a machine is advantageous for large volumes in particular.

In a further embodiment, it is provided that the machine comprises a device for bringing about a change of direction of the workpiece. In this way, two opposing narrow sides of the workpiece can be printed on first, while the workpiece is moving in a first direction. Following a change of direction, a further narrow side of the workpiece can be printed on, while the workpiece is moving in a second direction. The second direction can extend at an angle to, in particular at right angles to, the first direction.

### BRIEF DESCRIPTION OF THE DRAWINGS

FIG. 1 shows a schematic view of a process flow in accordance with a first embodiment.

FIG. 2 shows a process flow in accordance with a second embodiment.

FIG. 3 shows a process flow in accordance with a third embodiment.

### DETAILED DESCRIPTION OF THE PREFERRED EMBODIMENTS

The invention is described by way of example with the help of the attached figures, which show schematic embodiments for process flows. Although the embodiments that are described are intended as examples and have no limiting effect, possible embodiments can also be drawn upon to provide details of the invention. Moreover, individual features or modifications thereof can be used in another embodiment to form additional embodiments that are not described in detail.

The method described hereafter is used for printing on a number of, preferably all, faces of a panel-like workpiece. An inkjet printing device is used for this purpose. The workpiece to be printed on is a panel-like workpiece which has two wide faces and a number of lateral faces. The lateral faces are also referred to as narrow faces.

Sections of the workpiece that is processed as part of the methods described below comprise wood or a wood-based material. In particular, it can b e a kitchen worktop, a piece of furniture, a floor panel, a ceiling panel, a panel for use in the structural components industry, or the like.

The printing device described in the embodiments is an inkjet printing device which comprises a plurality of individually controllable nozzles, through which a printing medium is expelled.

### First Embodiment

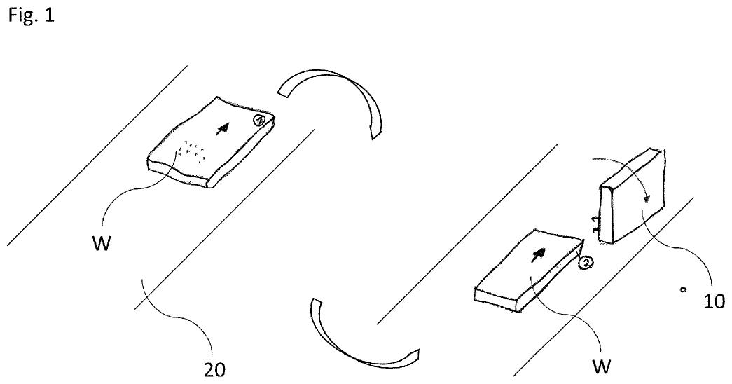

In the process flow illustrated in FIG. 1, the workpiece W is moved in a conveying direction by means of a conveyor system 20. In the embodiment example, the conveyor system is a circular conveyor belt, at least sections of which extend through the machine. By means of the conveyor system 20, the workpiece W is moved into the range of a printing device 10, which in a first process flow is arranged in such a way that a wide face of the workpiece is printed on. A full-surface printing process is employed here, so that a color is applied to the entire wide face of the workpiece.

Once the workpiece W has passed through the machine in a first pass, the workpiece is removed from the conveyor system 20 or is moved back to the entrance to the machine by a return mechanism (not shown). In a second pass, the printing device 10 is first pivoted through 90°, so that the printing device 10 is configured to print on a narrow face of the workpiece W.

Since the printing device 10 is equipped with a plurality of nozzles, each of which is individually controllable, it is possible to vary the application amount, and hence the application thickness, of the printing device 10 and hence to use the printing device 10 for both the full-surface coating of the wide face and the full-surface coating of the narrow face.

Once the workpiece W has been moved through the machine in a second pass, the workpiece W can be moved back to the infeed manually or by means of an appropriate return device, so that a further narrow face can be printed on. This process is continued until all faces of the workpiece W have been printed on in the machine.

### Second Embodiment

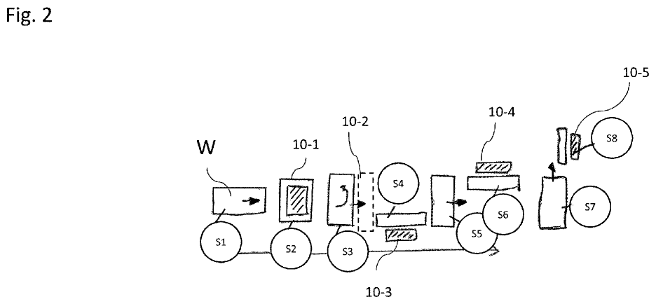

An example of a process flow for printing on a workpiece W is illustrated in schematic form in FIG. 2. The machine used for this process flow is characterized in that it comprises a plurality of printing devices, which are arranged in the machine.

The workpiece W is first moved by a conveyor system in a transport direction (step S1) and guided into the range of a first printing device 10-1. The first printing device 10-1 is configured to print on the entire surface of a wide face of the workpiece W.

The workpiece is then rotated through 180°, so that the second wide face of the workpiece W can be printed on by means of a second printing device 10-2 (step S2).

The workpiece W is then guided by the conveyor system into the range of a third printing device 10-3, which is configured to print on a narrow face of the workpiece (step S4). The printing in step S4 is also carried out in a pass. The workpiece W is then transported onwards (step S5), and a further narrow face (opposite the above-mentioned narrow face) is then printed on by a fourth printing device 10-4.

In a further step, the workpiece W is transported in a transport direction changed by 90° in relation to the original transport direction (step S7) and is guided into the range of a fifth printing device 10-5 (step S8). Then, after being transported onwards, a final narrow face of the workpiece W is printed on.

### Third Embodiment

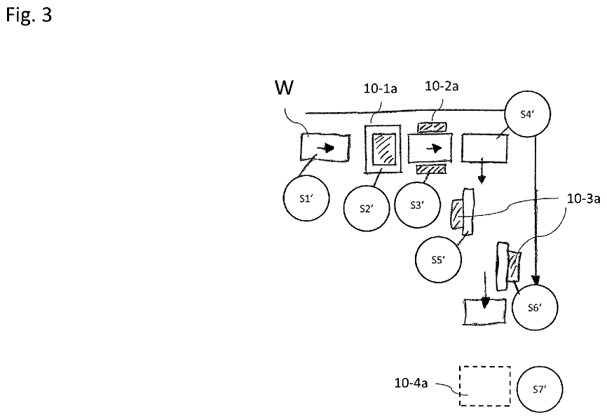

FIG. 3 shows a third embodiment of a method according to the invention. First of all, the workpiece W is moved in a first conveyor system (step S1′) and is then printed on in the region of a first wide face by means of a first printing device 10-la (step S2′).

In a further transport operation, the workpiece W enters the range of a second printing device 10-2a, which is configured to print on opposing narrow faces of the workpiece moved by the conveyor system (step S3′).

After being transported onwards (step S4′), the workpiece W is moved in a second conveyor system, which is designed substantially at right angles to the first convey or system. In this way, the workpiece W enters the range of a third printing device 10-3a, which is configured to refine the opposing narrow faces of the workpiece that have not yet been printed on (steps S5′, S6′).

After the workpiece has been rotated through 180°, it enters the range of a fourth printing device 10-4a, which is configured to print on a second wide face of the workpiece W (step S7′). Transporting the workpiece W within the machine ensures that the first wide face of the workpiece W, which was printed on in step S2′, is already dry, so that when the workpiece is rotated through 180°, the already printed surface of the workpiece W is not damaged.

1. A method for printing on a panel-like workpiece, which has wide faces and lateral faces, using a machine that comprises at least one digital printing device, the method comprising the following steps:
bringing about a relative movement between the workpiece and the at least one digital printing device; and
printing on at least one of the wide faces and at least one of the lateral faces of the workpiece in the machine.

2. The method according to claim 1, wherein and entire surface of each face of the workpiece is printed on.

3. The method according to claim 1, wherein the machine comprises a conveyor system in order to bring about a relative movement between the workpiece and the at least one digital printing device.

4. The method according to claim 1, wherein the wide or lateral faces of the workpiece are printed on in a number of passes.

5. The method according to claim 4, wherein the digital printing device is pivoted after printing on one of the wide or lateral faces of the workpiece.

6. The method according to claim 1, wherein the machine comprises a number of digital printing devices for printing on the wide or lateral faces of the workpiece.

7. The method according to claim 6, wherein the machine comprises at least four digital printing devices, wherein two of the digital printing devices are configured to print on in each case one of the wide faces of the workpiece and two of the digital printing devices are configured to print on in each case one of the lateral faces of the workpiece.

8. The method according to claim 6, wherein the relative movement is a movement of the workpiece and that a change of direction takes place as the workpiece passes through the machine.

9. The method according to claim 1, wherein the workpiece, at least in sections, consists of wood or wood-based materials.

10. A machine for printing on a panel-like workpiece,
which has wide faces and lateral faces, comprising:
at least one digital printing device; and
a device for bringing about a relative movement between the workpiece and the at least one digital printing device,
wherein the machine is configured to print on at least one of the wide faces and at least one of the lateral faces of the workpiece.

11. The machine according to claim 10, wherein the at least one digital printing device is pivotable.

12. The machine according to claim 10, wherein the machine comprises a number of digital printing devices for printing on the wide or lateral faces of the workpiece.

13. The machine according to claim 10, wherein the machine comprises at least four digital printing devices, wherein two of the digital printing devices are configured to print on in each case one of the wide faces of the workpiece and two of the digital printing devices are configured to print on in each case one of the lateral faces of the workpiece.

14. The machine according to claim 10, further comprising a device for rotating the workpiece.

15. The machine according to claim 10, further comprising a conveyor system in order to bring about a relative movement between the workpiece and the at least one digital printing device.

16. The method according to claim 1, wherein the at least one digital printing device is an inkjet printing device.

17. The method according to claim 3, wherein the conveyor system is a conveyor belt or one or more transport belts.

18. The machine according to claim 10, wherein the at least one digital printing device is an inkjet printing device.

19. The machine according to claim 14, wherein the device for rotating the workpiece is configured to rotate the workpiece through 180°.

20. The machine according to claim 15, wherein the machine comprises a device for bringing about a change of direction of the workpiece.
